(19) United States
(12) Patent Application Publication
(10) Pub. No.: US 2024/0383316 A1
(43) Pub. Date: Nov. 21, 2024

(54) DUST REDUCTION UNIT FOR RECREATIONAL VEHICLES

(71) Applicant: Nathan Johnston, Terranora (AU)

(72) Inventor: Nathan Johnston, Terranora (AU)

(21) Appl. No.: 18/385,392

(22) Filed: Oct. 31, 2023

(30) Foreign Application Priority Data
May 20, 2023 (AU) 2023901568

(51) Int. Cl. B60H 3/06; B01D 39/18; B01D 46/00

(52) U.S. Cl. CPC B60H 3/0641; B01D 39/18; B01D 46/0031; B01D 2279/40

(57) ABSTRACT

A dust reduction unit for a recreational vehicle has a body adapted to be affixed through a side wall of the recreational vehicle, an external vent in the body, fan within the body to draw air through the external vent and into the recreational vehicle and a filter within the body to catch dust before air passes into the recreational vehicle. The unit is characterized in that the external vent has collection wells for any water which may ingress into the vent, and drains connected to the wells so that water can escape the unit. The external vent has a grille on one of its sides for air intake and the external vent can be rotated with respect to the body so that the unit can be affixed on the left- or right-hand side of the recreational vehicle, which is useful for installation on recreational vehicles in any country.

### CROSS-REFERENCE TO RELATED APPLICATIONS

This is a U.S. Nonprovisional Patent Application filed under 35 U.S.C. 111 (a).

### BACKGROUND OF THE INVENTION

### 1. Field of the Invention

The present invention relates to recreational vehicles and, more particularly, to a dust reduction unit for recreational vehicles such as caravans and motorhomes.

### 2. Description of Related Art

Recreational vehicles can be covered in dust as they move along dust filled roads. The dust can also get inside the recreational vehicle. Air within the recreational vehicle is drawn out of cracks in the vehicle as wind moves past the recreational vehicle. There can be cracks around windows, fridge vents, hot water vents and roof vents.

Regulations which apply to the construction of living spaces require ventilation when gas appliances are installed therein. Many recreational vehicles have gas appliances. Accordingly, many recreational vehicles are required to at least two vents.

The air flow outside the recreational vehicle creates a negative pressure within the recreational vehicle that sucks dust into the vehicle via the vents and cracks.

The dust ingress problem is particularly bad when the recreational vehicle is travelling on unsealed roads or in dusty areas. Fine dust can enter the recreational vehicle even when the windows and doors of the vehicle are closed tight.

Pressure distributors are available as dust reduction units for recreational vehicles. These prior art pressure distributors are located on the roof of the recreational vehicle. Prior art pressure distributors are so heavy that the roofs of recreational vehicles need to be reinforced to take their weight and size. This creates a payload that leads to heavier vehicles and thereby additional drag and running costs.

Prior art pressure distributors also take up space on the roof of the recreational vehicle which could otherwise be used for solar panels. Another problem with prior art pressure distributors located on the rooftop of recreational vehicles is that the filters in those prior art pressure distributors need to be replaced frequently at additional cost. It can be an unsafe and burdensome task to get onto the roof of a recreational vehicle to install and maintain prior art pressure distributors.

A primary problem with prior art pressure distributors is that they create a leakage point for water during rain or cleaning. Leakages can lead to growth of mould within the recreational vehicle, which is harmful to the health of the occupants of the recreational vehicle. Leakages caused by prior art pressure distributors can create extensive damage within the roof and ceiling of the recreational vehicle.

Pressure distributors located on the roof of recreational vehicles can also create leakage because of condensation. During the night, cold air condenses on the roof the recreational vehicle where the prior art pressure distributors are located. The pressure distributors are made of aluminium, which readily transmits condensation. Because the prior art pressure distributors are located on the ceiling of the recreational vehicle, gravity causes the condensation to drip down through the roof of the recreational vehicle and into the cabin which leads to mould and roof damage.

Recreational vehicles need a dust reduction unit which is lightweight, minimizes water leakage, is easily accessible for maintenance, avoids an ingress point for condensation and preserves space for solar panels on the roof of recreational vehicles.

The object of the present invention is to overcome or at least substantially ameliorate the aforementioned problems.

### SUMMARY OF THE INVENTION

According to the present invention there is provided a dust reduction unit for a recreational vehicle, the unit comprising:
(a) a body adapted to be affixed through a side wall of the recreational vehicle;
(b) an external vent in the body;
(c) a fan within the body to draw air through the external vent and into the recreational vehicle; and
(d) a filter within the body to catch dust before air passes into the recreational vehicle, wherein the external vent has:
   i. one or more collection wells for any water which may ingress into the vent, and
   ii. one or more drains from the collection wells so that water can escape the unit.

The one or more drains are connected to the collection wells and enable water to escape the unit. The drains preferably include a strip well along the base of the unit. More preferably, the drains include one or more pocket wells at the base of the unit.

The external vent preferably has a grille on one of its sides for air intake. More preferably, the external vent can be rotated with respect to the body so that the unit can be affixed on the left- or right-hand side of the recreational vehicle.

The filter may be made of cotton gauze that maintains airflow and captures contaminants. Preferably the fan is adapted to sense when its rate of rotation is restricted indicating that the filter is blocking the regular rate of airflow into the unit. More preferably, the unit features a light to indicate to the user that the filter needs to be cleaned and/or replaced.

Any of the features described herein can be combined in any combination with any one or more of the other features described herein within the scope of the invention.

### BRIEF DESCRIPTION OF DRAWINGS

An embodiment of the invention will be described with reference to the following drawings, in which:

FIG. 1 is a perspective view of a recreational vehicle with a dust reduction unit according to an embodiment of the present invention.

FIG. 2 is a close-up view of the dust reduction unit of FIG. 1.

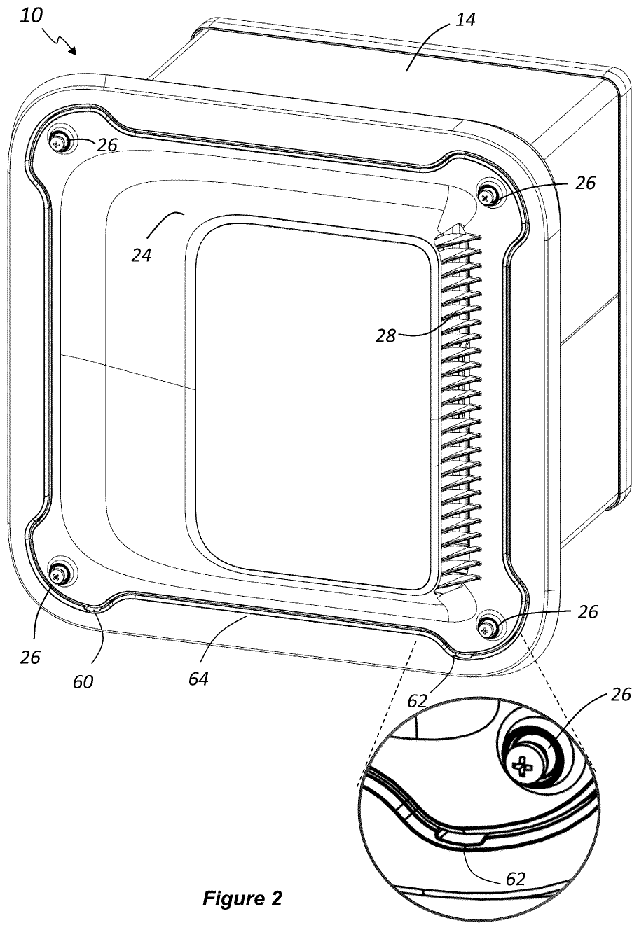

FIG. 3 is an exploded view dust reduction unit of FIG. 2.

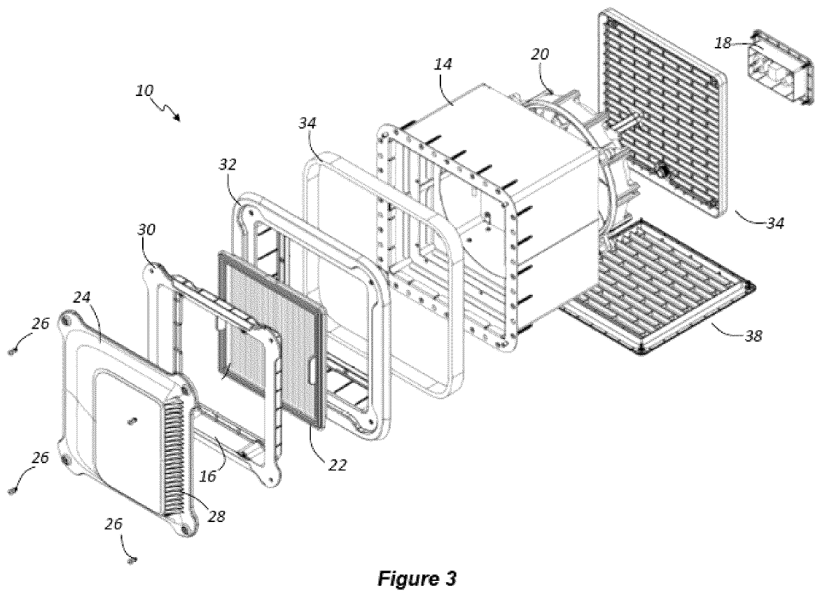

FIG. 4 is a perspective view of the external vent and frame of the dust reduction unit of FIG. 2.

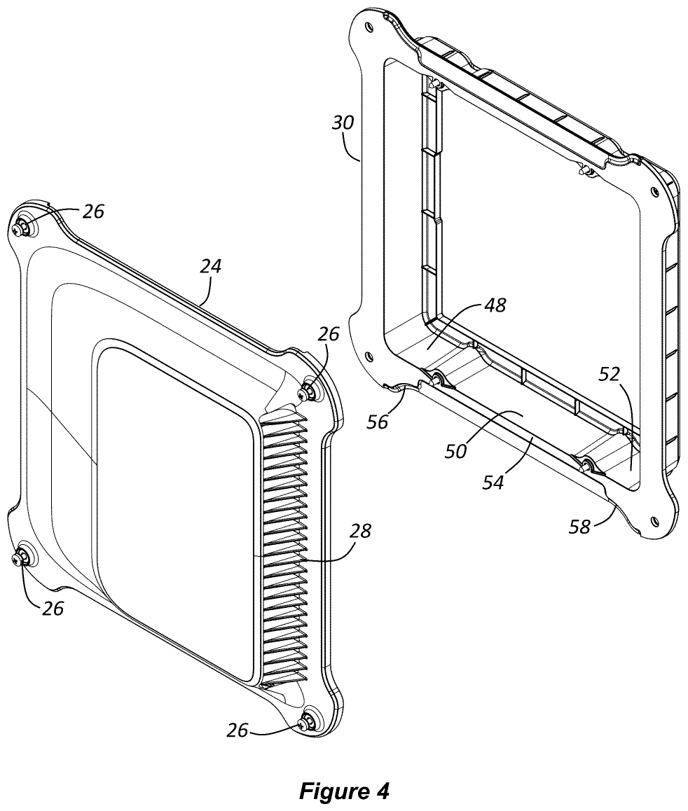

FIG. 5 is a front view of the operation switch and clean filter light of the dust reduction unit of FIG. 1.

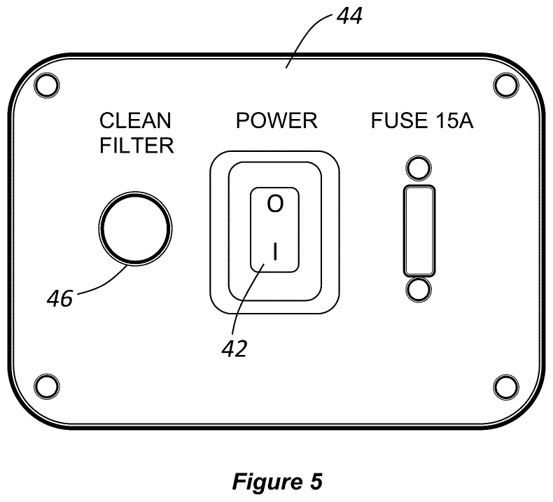

### DETAILED DESCRIPTION OF THE INVENTION

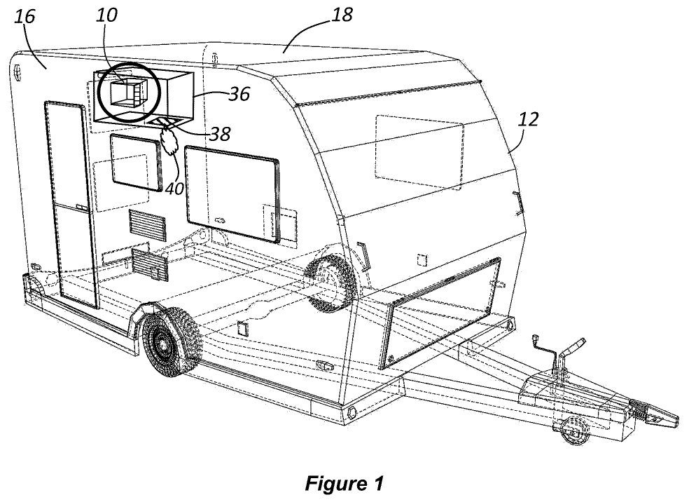

FIG. 1 shows the dust reduction unit 10 for a recreational vehicle 12. The dust reduction unit 10 has a body 14 which is adapted to be affixed through a side wall 16 of the recreational vehicle 12. Installing the unit 10 through the side wall 16 of the recreational vehicle 12 (as opposed to the roof 18) prevents water passing into the recreational vehicle 12 via gravity from the roof 18 of the recreational vehicle 12. The unit 10 is also more accessible for maintenance if it is installed on a sidewall 16 of the recreational vehicle 12.

The unit 10 has a fan 20 within the body 14 to draw air through the recreational vehicle 12. The fan 20 stops negative pressure being created within the recreational vehicle 12. The negative pressure is created by the wind passing over the recreational vehicle 12 (whether as the vehicle 12 moves or created by wind passing over the stationary vehicle 12). The negative pressure draws dust into the recreational vehicle 12. The unit 10 creates positive pressure in the recreational vehicle 12 so that dust is not drawn into the vehicle 10.

The fan 20 is electrically powered by a 12 Volt switch via a wire to a battery (not shown) of the recreational vehicle 12.

The unit 10 has a filter 22 positioned within the body 14 to catch dust particles. The filter 22 can be periodically removed for cleaning.

As the unit 10 is located on the sidewall 16 of the recreational vehicle 10, rather than on the roof 18 of the recreational vehicle 10, the filter 22 is much more accessible and easier to access during maintenance.

The filter 22 is preferably a High Efficiency Particulate Air (HEPA) filter. The filter 22 should have a Minimum Efficiency Reporting Value (MERV) of 8 and be able to screen particles of 3 to 10 microns in size at 85%. The filter 22 is preferably made of multiple layers of cotton gauze. The gauze maintains airflow but captures contaminants. The filter 22 can be cleaned rather than replaced so that the unit 10 is overall more environmentally friendly than prior art pressure distributors. The filter 22 can be easily removed from the unit 10 and tapped against a surface in order to dislodge the dust. Alternatively, the filter 22 can be hosed out.

This feature of the present invention provides a substantial contribution to the working of the invention over prior art designs. Prior art designs use paper filters. Paper filters come in a limited supply. A user of a dust reduction unit could easily run out of the paper filters in a location where new filters are not readily available. As recreational vehicles are designed for travelling, including to remote locations, a source of new paper filters is almost never readily accessible. The present invention substantially ameliorates this problem.

Furthermore, as prior art dust reduction units fit into the roof 18 of the recreational vehicle 12, the owner of the recreational vehicle 12 is required to get onto the roof 18 to replace the paper filter. When the hatch on the prior art dust reduction unit is opened and the paper filter is removed for replacement, the dust spills into the interior cabin space of the recreational vehicle 12, which creates a mess.

In the present invention, the unit 10 has an external vent 24. The external vent 24 can be attached or detached from the body 14 by screwing or unscrewing the screws 26. The external vent 24 can be taken off and rotated 180 degrees with respect to the body 14 so that the unit 10 can be affixed on the left- or right-hand side of the recreational vehicle. This provides a substantial contribution to the working of the invention because it means that the unit 10 can readily be adapted for recreational vehicles which travel on the left or ride hand sides of the road (depending on the rules in different countries).

The fact that the unit 10 is positioned in the sidewall 16 of the recreational vehicle 12 avoids water leakage from rain or during cleaning.

The external vent 24 has a grille 28 which faces toward the front of the recreational vehicle 12. The grille 28 stop the ingress of large particles into the filter 22.

The external vent 24 is affixed to a frame 30 which holds the filter 22 against a backing carriage 32 that sits in a frame 34 that is attached to the body 14 that holds the fan 20. At the rear of the body 14 is an external vent 34.

The unit 14 is typically installed into a cupboard 36 within the recreational vehicle 12. There is a cupboard vent 38 that allows air 40 to flow into the recreational vehicle 12. This pressurizes the recreational vehicle 12. The internal pressure created inside the recreational vehicle 12 stops the ingress of dust.

The unit 10 can be turned on and off from within the recreational vehicle 12 using the switch 42 on a panel 44. The panel 44 also has a clean filter light 46, which alerts the user when the fan 20 is no longer able to spin at its desired rate. This reduction in spin rate is caused by filter 22 being clogged with dust. This light 46 indicates to the user that the filter 22 needs to be cleaned.

Rain and water from washing the recreational vehicle 12 may enter the unit 10 via the grille 28 on the external vent 24 of the unit 10. The water could potentially clog the filter 22. In order to counter this problem, the unit 10 has three wells 48, 50 and 52. Any water which enters the wells 48, 50 and 52 is then drained from the unit 10 via a strip channel 54 and two pocket channels 56 and 58 which run through pocket holes 60 and 62 and strip hole 64 in the external vent 24 of the unit 10. If the unit 10 does not have a system for draining water then the filter gets wet and clogged and the unit 10 becomes inoperative or less effective. Therefore, the drainages system of the present invention provides a substantial contribution to the working of the invention.

The dust reduction unit 10 thereby fulfils the objects of the invention to be comparatively lightweight, minimize water leakage, be easily accessible for maintenance, avoid an ingress point for condensation and preserve more space for solar panels on the roof of recreational vehicles.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A dust reduction unit for a recreational vehicle, the dust reduction unit comprising:
(a) a body adapted to be affixed through a side wall of the recreational vehicle;
(b) an external vent in the body, wherein the external vent includes one or more sides;
(c) a fan within the body configured to draw air through the external vent and into the recreational vehicle;
(d) a filter within the body configured to catch dust before air passes into the recreational vehicle;
(e) one or more collection wells configured to collect any water that ingresses into the vent; and
(f) one or more drains connected to the collection wells, enabling water to escape the dust reduction unit.

2. The dust reduction unit of claim 1, wherein the one or more drains include a strip well along the base of the dust reduction unit.

3. The dust reduction unit of claim 1, wherein the one or more drains include one or more pocket wells at the base of the dust reduction unit.

4. The dust reduction unit of claim 1, wherein the external vent includes a grille on one of its sides for air intake.

5. The dust reduction unit of claim 1, wherein the external vent is configured to rotate with respect to the body, enabling the dust reduction unit to be affixed on the left-hand side or right-hand side of the recreational vehicle.

6. The dust reduction unit of claim 1, wherein the filter is made of cotton gauze that maintains airflow and captures contaminants.
